(19) United States
(12) Patent Application Publication
(10) Pub. No.: US 2026/0220486 A1
(43) Pub. Date: Jul. 30, 2026

(54) INFORMATION HANDLING SYSTEM WITH MODEL RECOMMENDATION BASED ON PERFORMANCE AND APPLICATION CONTEXT

(71) Applicant: DELL PRODUCTS L.P., Round Rock, TX (US)

(72) Inventors: Tyler Cox, Austin, TX (US); Rishi Mukherjee, Bangalore (IN); Swagat Parida, Bangalore (IN); Spencer Bull, Conroe, TX (US)

(21) Appl. No.: 19/036,143

(22) Filed: Jan. 24, 2025

(51) Int. Cl. G06N 3/10; G06N 3/063

(52) U.S. Cl. CPC G06N 3/10; G06N 3/063

(57) ABSTRACT

An information handling system stores an artificial intelligence (AI) model hub, and receives a request to execute an AI model within an application. In response to the request, the system collects performance related data from a plurality of AI models. Based on the collected performance related data, the system determines a workflow for the application. Based on the workflow, the system outputs a recommended AI model to be executed within the application.

### FIELD OF THE DISCLOSURE

The present disclosure generally relates to information handling systems, and more particularly relates to recommending a model based on performance and application context within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system stores an artificial intelligence (AI) model hub. The system may receive a request to execute an AI model within an application. In response to the request, the system may collect performance related data from a plurality of AI models. Based on the collected performance related data, the system may determine a workflow for the application. Based on the workflow, the system may output a recommended AI model to be executed within the application.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system including an information handling system and a server according to at least one embodiment of the present disclosure;

FIG. 2 is a flow diagram of a method for recommending a model based on performance and application context within an information handling system according to at least one embodiment of the present disclosure; and

FIG. 3 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

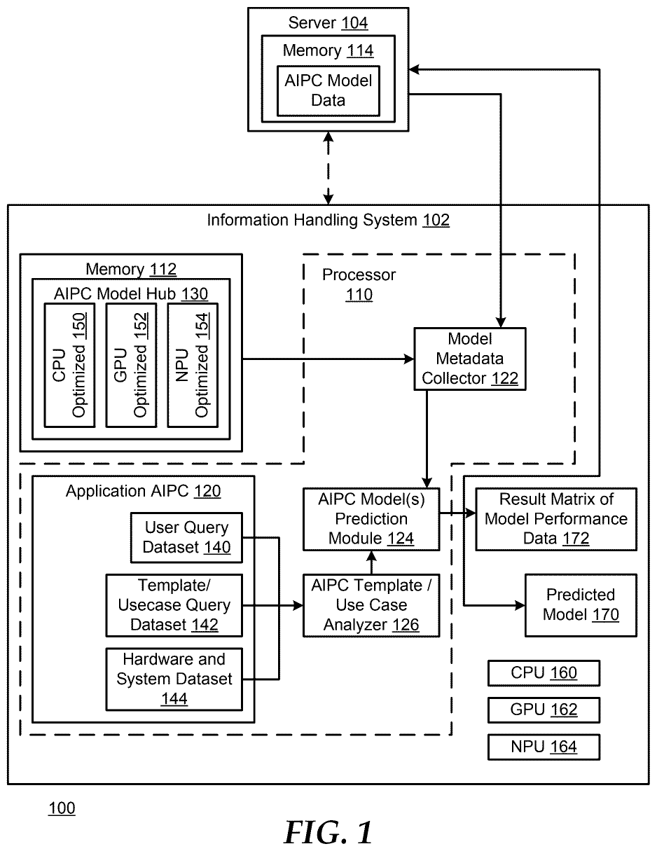

FIG. 1 illustrates a system 100 including an information handling system 102 and a remote or cloud server 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 102 includes a processor 110 and a memory 112, and server 104 includes a memory 114. Processor 110 may execute multiple modules including, but not limited to, an application artificial intelligence personal computer (AIPC) 120, a model metadata collector 122, an AIPC model prediction module 124, and an AIPC template/use case analyzer 126. While model metadata collector 122, AIPC model prediction module 124, and AIPC template/use case analyzer 126 are illustrated and described herein as being executed by processor 110, each of these may be separate hardware components to perform operations separate from the processor without varying from the scope of this disclosure.

Memory 112 may store any data associated with information handling system 100, such as an AIPC model hub 130. Memory 114 of remote server 104 may store any suitable data, such as AIPC model data or the like. Application AIPC 120 may generate one or more datasets including, but not limited to, a user query dataset 140, a template/use case query dataset 142, and a hardware and system dataset 144. AIPC model hub 130 includes different AI models for components of information handling system 102. The different AI models may be for an optimized central processing unit (CPU) 150, an optimized graphics processing unit (GPU) 152, and an optimized neural processing unit (NPU) 154. Information handling system 102 also includes a CPU 160, a GPU 162, and an NPU 164. Information handling system 102 may include additional components without varying from the scope of this disclosure.

Previous information handling systems were only able to perform basic predictive analysis for generic use cases. However, these previous information handling systems fail to predict and suggest suitable models for specific use cases when analyzing a large number of model metadata and performance data, for a variety of target system configurations. Information handling system 102 may be improved by processor 110 analysing the expected use of a model from datasets associated with the use case description, historical examples, and domain context. Based on these datasets, processor 110 may predict and recommend an AIPC model. Information handling system 102 may also be improved by processor 110 performing operations to score and recommend model suitability given an expected usage and performance profile.

During operation of information handling system 102, processor 110 may receive a request for an AI template based on any suitable condition or event. For example the AI template request may result from an attempt to create or develop a particular AI template, may be the result of a user or individual requesting an AI template/model to operate in conjunction with a particular application, or the like. In response to a request, processor 102 may perform one or more operations to provide a recommended AI model for the use case associated with the request.

In response to processor 102 receiving the AI template request, the processor may execute application AIPC 120, model metadata collector 122, AIPC model prediction module 124, and AIPC template/use case analyzer 126. For clarity, operations performed by processor 102 through execution of application AIPC 120, model metadata collector 122, AIPC model prediction module 124, or AIPC template/use case analyzer 126 will be described as being performed by the corresponding component of the processor. For example, operations described herein as being performed by application AIPC 120 may be performed by processor 102 through the execution of the application AIPC.

In response to a request for an AI model, AIPC model metadata collector 122 may collect datasets from both AIPC model hub 130 in memory 112 and memory 114 of remote server 104. These datasets may include data related to performance metrics of different AI models, such as models executed in CPU 160, GPU 162, or NPU 164. In certain examples, the performance metrics may include, but are not limited to, average inference times, power consumptions, and energy consumptions for CPU 160, GPU 162, and NPU 164. The performance metrics data may further include other configuration parameters, such as version, system configurations, and test result dataset. Exemplary model performance metrics are illustrated in Tables 1-5 below.

TABLE 1
Model Performance Metrics

| | | | Speed | Speed | | |
|---|---|---|---|---|---|---|
| | | mAP^{val} | CPU ONNX | A100 TensorRT | | |
| Model | size (pixels) | 50-95 | (ms) | (ms) | params (M) | FLOPs (B) |
| Model 1 | 640 | 37.3 | 80.4 | 0.99 | 3.2 | 8.7 |
| Model 2 | 640 | 44.9 | 128.4 | 1.20 | 11.2 | 28.6 |
| Model 3 | 640 | 50.2 | 234.7 | 1.83 | 25.9 | 78.9 |
| Model 4 | 640 | 52.9 | 375.2 | 2.39 | 43.7 | 165.2 |
| Model 5 | 640 | 53.9 | 479.1 | 3.53 | 68.2 | 257.8 |

TABLE 2
NPU Performance(ms) vs Precision

| Model | FP16 | INT8 |
|---|---|---|
| Model 1 | 26 | 15 |
| Model 2 | 56 | 25 |
| Model 3 | 121 | 60 |
| Model 4 | 235 | 108 |

TABLE 3
Avg. Inference Time(ms) CPU vs GPU vs NPU

| Model | CPU_Pytorch | CPU_ONNX | GPU_Pytorch | GPU_ONNX | NPU_Pytorch | NPU_ONNX |
|---|---|---|---|---|---|---|
| Model 1 | 28 | 22 | 10 | 20 | 26 | 15 |
| Model 2 | 45 | 39 | 11 | 40 | 56 | 25 |
| Model 3 | 85 | 83 | 14 | 90 | 121 | 60 |
| Model 4 | 861 | 170 | 19 | 175 | 235 | 108 |

TABLE 4
Power Consumption(mW) CPU vs GPU vs NPU

| Model | CPU_Pytorch | CPU_ONNX | GPU_Pytorch | GPU_ONNX | NPU_Pytorch | NPU_ONNX |
|---|---|---|---|---|---|---|
| Model 1 | 27000 | 27000 | 23000 | 29000 | 2300 | 1800 |
| Model 2 | 27000 | 27000 | 27000 | 31000 | 2400 | 2000 |
| Model 3 | 27000 | 27000 | 45000 | 33000 | 2400 | 2000 |
| Model 4 | 27000 | 27000 | 51000 | 40000 | 2500 | 2200 |

TABLE 5
Energy Consumption(Wms) CPU vs GPU vs NPU

| Model | CPU_Pytorch | CPU_ONNX | GPU_Pytorch | GPU_ONNX | NPU_Pytorch | NPU_ONNX |
|---|---|---|---|---|---|---|
| Model 1 | 756 | 594 | 230 | 580 | 60 | 27 |
| Model 2 | 1215 | 1053 | 297 | 1240 | 134 | 50 |
| Model 3 | 2295 | 2241 | 630 | 2970 | 290 | 120 |
| Model 4 | 4347 | 4590 | 969 | 7000 | 588 | 238 |

As illustrated in Tables 1-5, the different models, such as AI models of model hub 130 stored in memory 112, may have different performance metrics. In certain examples, model metadata collector 122 may provide the performance metrics to model prediction module 124. AIPC template/use case analyzer 126 may receive datasets from application AIPC 120. These datasets may include user query dataset 140, template/use case query dataset 142, hardware and system dataset 144. In an example, the user query dataset 140 may include data associated with the query, such as keyword to identify the desired AI model. Template/use case query dataset 142 may include data generated by application AIPC 142 for possible templates for a use case based on the query. In certain examples, hardware and system dataset 144 may include data associated with the components installed in information handling system 102 and the system configurations of the information handling system.

Based on these datasets, AIPC template/use case analyzer 126 may create an AIPC template for the requested AI model. In an example, the AIPC template may be a detailed workflow of the intended application to be executed along with the AI model. AIPC template/use case analyzer 126 may provide the AIPC template to the model prediction module 124. Based on the performance metrics from model metadata collector 122 and the AI template from AIPC template/use case analyzer 126, model prediction module 124 may predict the required AIPC model or sequence of AIPC models 170. For example, model prediction module 124 may compare requirements of the AI template to the performance metrics for each of the AI models in AI model hub 130 to determine a recommended AI model or a recommended sequence of AI models that best fit the query of the user.

In an example, model prediction module 124 may score or rank the AI models in AI model hub 130. The ranking or scoring of the AI models may be performed in any suitable manner. For example, model prediction module 124 may provide a higher rank or score to an AI model that meets or accomplishes more requirements of the intent or use case in the corresponding template as compared to another AI model. In certain examples, model prediction module 124 may determine that the AIPC template does not correspond to or match any AI models in AIPC model hub 130. In this situation, model prediction module 124 may determine a result matrix of model performance data 172. In an example, result matrix 172 may include performance data for the different components that may execute the AIPC model within information handling system 102.

In an example, processor 110 may receive a request to suggest a model based on a particular context and description of the model. Based on the request, processor 110 may execute model metadata collector 122, AIPC model prediction module 124, and AIPC template/use case analyser 126 to provide a predicted or recommended AI model. In certain examples, processor 110 may provide one or more appropriate models from model hub 130 based on the applicable use-case, the desired outcome of the intent, and presence of alternate models if available.

In this example, AIPC template/use case analyser 126 may identify possible use-cases by interacting with an individual to co-relate possible models within AIPC model hub 130 with use-case. Based on the determined co-related, AIPC model prediction module 124 may predict the optimized model or models.

In an example, processor 110 may receive a request to suggest an optimized model with consideration of the intent, hardware capabilities like processor 110, memory, and storage 112. For example, a user may request to install a template or AI model which will help in converting speech to text with multilingual support. In this example, processor 110 may execute model metadata collector 122, AIPC model prediction module 124, and AIPC template/use case analyser 126 to select or determine an optimized AI model. This AI model may be appropriate for the intended requirement applicable for the desired hardware platform/configuration of information handling system 102 to yield the desired result.

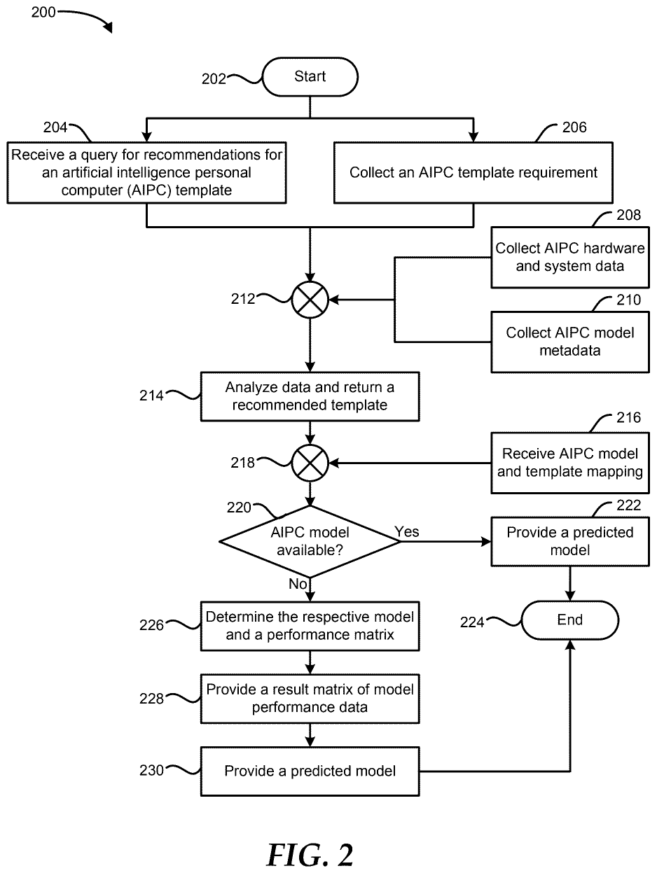

FIG. 2 shows a method 200 for recommending a model based on performance and application context within an information handling system according to at least one embodiment of the present disclosure, starting at block 202. Not every method step set forth in this flow diagram is always necessary, and certain steps of the methods may be combined, performed simultaneously, in a different order, or perhaps omitted, without varying from the scope of the disclosure. FIG. 2 may be employed in whole, or in part, processor 110 of information handling system 100 of FIG. 1, or any other type of controller, device, module, processor, or any combination thereof, operable to employ all, or portions of, the method of FIG. 2.

At block 204, a query for recommendation for an AIPC template is received. At block 206, an AIPC template requirement is received. While blocks 204 and 206 are illustrated as being perform substantially concurrently, block 206 may be performed in response to the reception of the query without varying from the scope of this disclosure. In an example, the query for recommendations for the AIPC template may be based on an application being executed within the information handling system. For example, the query may be for a speech to text model that may execute during a video chat application and the AIPC template may be a video analysis template.

At block 208, AIPC hardware and system data is collected. In an example, the AIPC hardware data may be associated with hardware capabilities of the information handling system, such as processor, memory and storage. The AIPC data may be associated with the operating system and other over system capabilities. At block 210, AIPC model metadata is collected. In certain examples, the AIPC model metadata may be collected from any suitable source, such as an AIPC model hub stored in a memory of the information handling system, from a remote server in communication with the information handling system, or the like. The AIPC model metadata may be any suitable metadata including, but not limited to, performance metrics for different processing units of the information handling system, configuration parameters, such as version and system configurations, and a test result dataset. The performance metrics may include average inference times, power consumptions, energy consumptions or the like for the different processing units. The different processing units include, but are not limited to, a CPU, a GPU, and an NPU.

At block 212, the query, the AIPC template requirement, the AIPC hardware and system data, and the AIPC model metadata are all provided as inputs to a hardware component of the information handling system. In an example, the hardware component may be a processor or a hardware AIPC template and use case analyser component. At block 214, the received or collected data is analysed and a recommended template is provided. In certain examples, the recommended template may be a detailed workflow of the intended application to be executed along with an AIPC model.

At block 216, an AIPC model and template mapping is received. The AIPC model and template mapping is combined with the recommended template at block 218. Based on the AIPC model and template mapping, the processor may determine a recommended or predicted model for the recommended template. In certain examples, the predicted model may be a sequence of AIPC models for the recommended template.

At block 220, a determination is made whether the AIPC model is available within the information handling system. In an example, the determination of whether the AIPC model is available may be based on whether a predefined model is available for the recommended template. If the AIPC model is available, this AIPC model is provided as a predicted or recommended model at block 222 and the flow ends at block 224. In an example, the predicted model may be executed in conjunction with the application, such that the predicted model may be a sub-routine within the application or may receive data from the application to be executed within the predicted model.

If the AIPC model is not available, both a respective model and a performance matrix are determined at block 226. In certain examples, the respective model may be determined or predicted based on requirements of the intended application to be executed within the information handling system. At block 228, a result matrix of model performance data is provided. In an example, the result matrix may include performance data for the different components that may execute the AIPC model within the information handling system. At block 230, the predicted model is provided, and the flow ends at block 224. In certain examples, the predicted model may be executed in conjunction with the intended application.

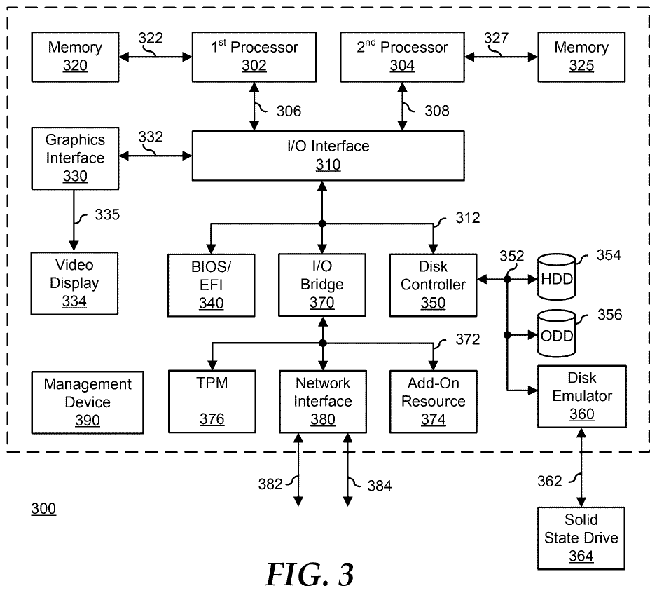

FIG. 3 shows a generalized embodiment of an information handling system 300 according to an embodiment of the present disclosure. Information handling system 300 may be substantially similar to information handling system 102 of FIG. 1. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 364, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 364, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332 and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 4394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312 or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300.

Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store an artificial intelligence (AI) model hub; and
a processor to communicate with the memory, the processor to:
receive a request to execute an AI model within an application;
in response to the request, collect performance related data from the AI model hub;
based on the collected performance related data, determine a workflow for the application; and
based on the workflow, output a recommended AI model to be executed within the application.

2. The information handling system of claim 1, further comprising a neural processing unit to communicate with the processor, the neural processing unit to execute the recommended AI model during the execution of the application by the processor.

3. The information handling system of claim 1, wherein the processor further to output a result matrix of the collected performance related data.

4. The information handling system of claim 1, wherein the collected performance related data is a set of performance metrics for a central processing unit, a graphics processing unit, and a neural processing unit.

5. The information handling system of claim 1, wherein the processor further to retrieve a set of model metadata from an application artificial intelligence personal computer, wherein the workflow is further determined based on the set of model metadata.

6. The information handling system of claim 5, wherein the model metadata includes a user query dataset, a use case query dataset, and a hardware and system dataset.

7. The information handling system of claim 1, wherein the collected performance related data is received from a remote server.

8. The information handling system of claim 1, wherein the workflow is a set of operations to be executed to perform actions of the AI model.

9. The information handling system of claim 1, wherein the recommended AI model is part of a sequence of AI models for execution in the application.

10. A method comprising:
storing, in an information handling system, an artificial intelligence (AI) model hub;
receiving, by the information handling system, a request to execute an AI model within an application;
in response to the request, collecting performance related data from the AI model hub;
based on the collected performance related data, determining a workflow for the application; and
based on the workflow, outputting a recommended AI model to be executed within the application.

11. The method of claim 10, further comprising executing, by a neural processing unit of the information handling system, the recommended AI model during the execution of the application by the processor.

12. The method of claim 10, further comprising outputting a result matrix of the collected performance related data.

13. The method of claim 10, wherein the collected performance related data is a set of performance metrics for a central processing unit, a graphics processing unit, and a neural processing unit.

14. The method of claim 10, further comprising retrieving a set of model metadata from an application artificial intelligence personal computer, wherein the workflow is further determined based on the set of model metadata.

15. The method of claim 14, wherein the model metadata includes a user query dataset, a use case query dataset, and a hardware and system dataset.

16. The method of claim 10, further comprising: receiving the collected performance related data is received from a remote server.

17. The method of claim 10, wherein the workflow is a set of operations to be executed to perform actions of the AI model.

18. The method of claim 10, wherein the recommended AI model is part of a sequence of AI models for execution in the application.

19. A system comprising:
a remote server including a first memory to store a first set of performance related data associated with a plurality of components; and
an information handling system to communicate with the remote server, the information handling system including:
a second memory to store an artificial intelligence (AI) model hub;
a processor to:
receive a request to execute an AI model within an application;
in response to the request, collect a second set of performance related data from the AI model hub and the first set of performance related data from the remote server;
based on the first and second sets of performance related data, determine a workflow for the application; and
based on the workflow, output a recommended AI model to be executed within the application; and
a neural processing unit to execute the recommended AI model during the execution of the application by the processor.

20. The information handling system of claim 19, wherein the components include a central processing unit, a graphics processing unit, and the neural processing unit.
